(19) United States
(12) Patent Application Publication
(10) Pub. No.: US 2007/0170688 A1
(43) Pub. Date: Jul. 26, 2007

(54) Real-Time Bicycle-Mounted Pedal Stroke Power Analysis System

(76) Inventor: Edward M. Watson, Madison, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/626,746

(22) Filed: Jan. 24, 2007

Related U.S. Application Data
(60) Provisional application No. 60/761,937, filed on Jan. 25, 2006.

(51) Int. Cl. B62M 1/02

(52) U.S. Cl. 280/260

(57) ABSTRACT

An apparatus and system for monitoring, analyzing and displaying the power applied by a user during operation of a pedal assembly are described. A hub assembly includes a sensor such as one or more strain gauges and is mounted in the rear wheel of a bicycle for detecting the torque and angular velocity applied during pedaling. The detected information is then transmitted to a receiver module, which sends the information to a computer that is fixedly coupled to, for example, the handlebars of the bicycle. The computer then processes the received information and outputs to a display a real-time or near real-time graphical representation of the power applied during the pedal stroke.

### CROSS REFERENCE TO RELATED APPLICATION

This application claims the benefit of provisional patent application Ser. No. 60/761,937 filed Jan. 25, 2006.

### BACKGROUND OF THE INVENTION

1. Field of the Invention

This invention relates to a bicycle or other device that is powered by user operation of a pedal assembly, and more particularly to a system for monitoring, analyzing and displaying the power applied by a user during operation of the pedal assembly.

2. Discussion of the Related Art

Stationary trainers and fixed spinner bikes outfitted with a device used to analyze pedal stroke are known in the art. Typically, however, the data gathered by the device is only available after the rider has completed his or her training session. In such devices, a data collection device is interfaced with, for example, a computer. A computer program is then used to extract and analyze the data collected during the training session. One particular disadvantage of this type of device is that the data collected by the device is not available to the rider during the training session. Furthermore, prior devices are not capable of use in a real-time environment in which the rider can use the data to monitor and improve pedal stroke efficiency on the fly.

A system for measuring power expended during operation of a bicycle is disclosed in Ambrosina et al U.S. Pat. No. 6,418,797, hereby incorporated by reference. The '797 patent discloses a torque measurement system incorporated into the hub of a bicycle, to determine torque applied by the user. The applied torque measurements are then used to calculate power, in a manner as is known. A commercial embodiment of the technology disclosed in the '797 patent is available from Saris Cycling Group, Inc. of Madison, Wis. under the designation POWERTAP.

The system disclosed in the '797 patent senses and displays total power application data, which provides a user with a powerful tool that can be used on the fly during an exercise session to monitor and adjust total power output. The power application data can also be used after an exercise session is completed, in order to analyze various parameters of the exercise session and to plan future exercise sessions. However, the system of the '797 patent is not used in a real time environment to sense and display information regarding application of power during a pedal stroke.

It is therefore an object of the present invention to provide a device powered by user operation of a pedal assembly that continuously monitors, analyzes and displays pedal stroke power application data to a rider during use in a real time environment, such as during a bicycle race or outdoor training ride, or during an indoor stationary exercise training session such as on a spin bike or on a bicycle trainer.

Another aspect of the present invention is to provide a system whereby the data collected by the device may be used to improve the fit of the bicycle to an individual rider such that the bicycle is set up so as to maximize the efficiency of the rider's pedal stroke.

Yet another object of the present invention is to use the data collected by the device to sense and display the symmetry between the right and left pedal strokes of the individual rider. As such, the data from the device can be used to train the rider to apply power in his or her pedal strokes more evenly between the left and right legs.

Another object of the present invention is to use the data collected and displayed by the device to train the rider to apply power evenly throughout the 360 degrees of the pedal stroke.

### SUMMARY OF THE INVENTION

The present invention is a bicycle power sensing and display system that provides immediate feedback to the bicycle or spin bike rider as to the application of power during the pedal stroke, while the bicycle or spin bike is being ridden (rather than providing pedal stroke power analysis after completion of a ride or exercise session). In this manner, the power application information can be utilized by the rider during training and/or racing, so that the rider can make adjustments in his or her pedal stroke on the fly in real training or racing conditions. The device and system of the present invention may be configured to work with or be affixed to a traditional bicycle for use during competition or training to provide graphical information to the user regarding pedal stroke power application, or may be used to provide such information to a user in connection with a spin bike or stationary bicycle trainer.

Various other features, objects and advantages of the present invention will be made apparent from the following detailed description taken together with the drawings.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic pictorial view of a bicycle equipped with one embodiment of the power sensing and display system of the present invention;

FIG. 2 is a flow chart of the operation of the power sensing and display system of the present invention;

FIG. 3 is a pictorial representation of a representative embodiment for a graphical user interface using the power sensing and display system of the present invention; and

FIG. 4 is a pictorial representation of another representative embodiment of a graphical user interface using the power sensing and display system of the present invention.

### DETAILED DESCRIPTION

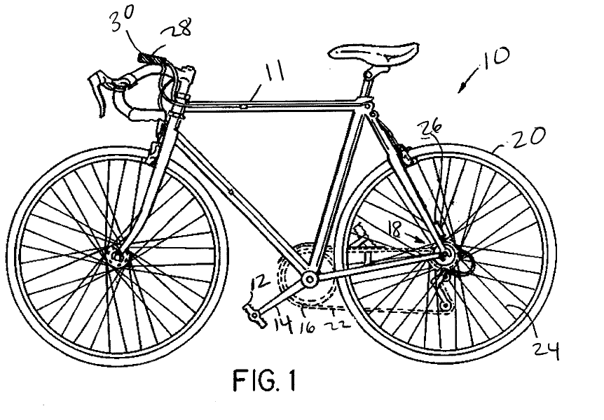

Turning now to the drawings, and initially to FIG. 1, a schematic pictorial view of a bicycle 10 equipped with the power sensing and display system of the present invention is shown. The bicycle 10 includes a frame 11, which rotatably supports a pair of pedals 12 connected by crank arms 14 to a chain ring 16. The chain ring 16 is coupled to the hub assembly 18 of the rear wheel 20 by a chain 22. The bicycle 10 is powered by a cyclist providing rotational forces to the chain ring 16 via the pedals 12 and crank arms 14. The rotation of the chain ring 16 is transferred by the chain 22 to the rear wheel hub assembly 18, which carries the rear wheel 20 into rotation via spokes 24 to drive the bicycle into motion.

As noted above, the rear wheel hub assembly 18 has a construction as set forth in Ambrosina et al U.S. Pat. No. 6,418,797, and is operable to sense the applied torque in and angular velocity of the hub assembly 18. The detected torque-related and angular velocity related values are sensed by electronic components within the hub assembly 18, and are then transmitted by, for example, radio frequency waves, to a receiver module 26, which is mounted in any satisfactory location on the frame 11 of bicycle 10. The receiver module 26 transmits such information, such as via a wire connection, to a cycle computer 28 which can be mounted on the handlebars of the bicycle 10 or elsewhere on the frame 11. Alternatively, the hub assembly 18 may incorporate a signal transmission system that transmits signals wirelessly to a receiver associated with cycle computer 28. The computer 28 uses the torque-related and angular velocity related information to compute applied power and velocity, and can display the measured or calculated information on a display as desired.

During operation, the applied hub torque-related measurements are taken at a high frequency, in order to provide relatively fine measurements throughout the 360 degrees of each pedal stroke. Representatively, the applied hub torque-related measurements may be taken on the order of 60 times per second, although it is also contemplated that hub torque measurements may be taken at more frequent intervals, e.g. approximately 120 times per second. In this manner, the hub 18 it is subjected to the rotational torque both profile over the stroke of the pedal assembly. A typical bicycle-operating cadence (rate of revolution of the pedal assembly) is in the range of 60 to 140 rpm. Taken at the high end, e.g. 140 rpm, the pedal assembly may be operated at a rate of approximately 2.3 revolutions per second. Using a torque measuring frequency of approximately 60 times per second, torque measurements can thus be taken at a typical maximum cadence at approximately every 13 to 14 degrees of revolution, providing approximately 25 data points of user-applied power for each pedal revolution. The resolution will be improved proportionally at lower, more typical cadences in the range of 60 to 90 rpm. The power data points are then analyzed in a real time manner, on the fly, during operation of the bicycle 10.

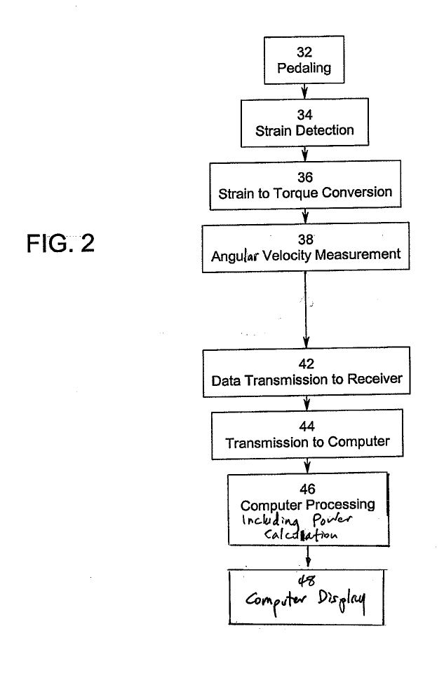

Turning now to FIG. 2, a flow chart of one embodiment of the power sensing and display system of the present invention is shown. At the outset, a rider begins pedaling the bicycle 10 at step 32, either while the bicycle 10 is fixed to a stationary bicycle trainer or in a real environment. Alternatively, step 32 may involve operation of pedals associated with a stationary bicycle trainer or spin bike. Upon the pedaling of the cycle, the hub assembly 18 senses the power delivered to rotate the driven wheel of the bicycle and thereby move the bicycle. In one embodiment, the power is detected by sensing strain at step 34 through the use of strain gauges and the like in one or more components, such as an internal torque tube, which transfer the chain forces to the wheel assembly, converting the strain measurement into a torque measurement at step 36. The measurements are taken at a high frequency as noted above, so that numerous measurements are made during rotation of the pedal assembly. Simultaneously, angular velocity of the wheel is determined at step 38.

The hub assembly 18 then transmits the high frequency measurements at step 42 via radio frequency waves to the receiver module 26. Hub assembly 18 bundles average information along with other data to be transferred to bicycle computer 28, which is then communicated to bicycle computer 28 at frequent intervals, such as on the order of every 1.26 seconds. Alternatively, the information may be sent via inductive coupling or infrared link. The receiver module 26 then transmits the information at step 44 via a conductive wire, or the like, to the computer 28. The computer then processes the received information at step 46, including the calculation of applied power based on the torque and angular velocity measurements, and then displays the received information in a graphical form to the user at step 48 in a real-time or near-real-time manner. The user is thus able to obtain very frequent feedback as to the pedal stroke of profile (again, on the order of every 1.26 seconds). Alternatively, it is contemplated that the data samples from assembly 18 may be communicated directly to the computer 28, instead of communicating bundled, average information. While this arrangement is theoretically possible, it has not been found to be practical for production use.

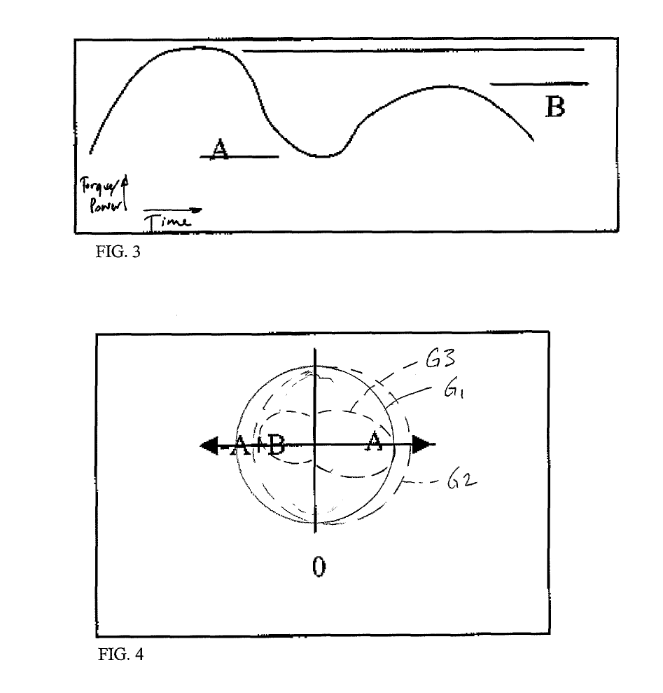

Referring now to FIG. 3 an example of a graphical display of one embodiment of the present invention is shown. After receiving and calculating the applied power information, the cycle computer 28 displays a graphic that represents power applied during the pedal stroke. Representatively, with reference to FIG. 3, the data provides a peak to valley (A) torque differential, which is represented by a numeric value in which a lower number is preferable. A peak-to-peak difference is also determined, to illustrate the difference in power application between the rider's left and right legs. Again, a lower value is preferable. These two parameters are then quantified and displayed on display 30 in a real time manner at the bicycle-mounted computer 28 in a graphic form, to give the rider visual feedback of the real time (or at least very near real time) pedal analysis. In this type of graphic, a graphic approaching a straight line represents an ideal balanced and symmetrical application of power throughout the pedal stroke when the applied power is equal for both of the user's legs and is consistently applied during both the down stroke and the upstroke of the pedal cycle.

Turning now to FIG. 4, another example of a graphical representation that may be displayed at the display 30 is shown. In this particular graphic, a symmetrically centered circle, shown at G1, represents an ideal application of power throughout the pedal stroke when the applied power is the same for both of the user's legs and is consistently applied during both the down stroke and the upstroke of the pedal cycle. A graphic such as G2 represents an asymmetrical application of power, in which the power applied by one of the user's legs is greater than that applied by the other. A change in the “A” value increases or decreases the “figure 8” shape of the graphic representation of FIG. 4 (an example of which is illustrated at G3). A change in the “B” value increases or decreases the side-to-side symmetry of the graphic representation of FIG. 4.

The present invention thus provides a pedal cycle power analysis system that is in the bicycle itself. This enables a user to have pedal cycle power information any time the bicycle is being operated, such as when mounted to a trainer or when the bicycle is being ridden outdoors or on a track by the user. In any scenario, the user is able to have real-time feedback, while riding the bicycle, as to the power that is being applied during the pedal stroke so that the user can make adjustments as necessary to provide a desired or optimal power distribution.

Various alternatives and modifications are contemplated as being within the scope of the following claims, particularly pointing out and distinctly claiming the subject matter regarded as the invention.

I claim:

1. A bicycle, comprising:
a frame and a pair of wheels, one of which is driven by operation of a rotatable pedal assembly;
a sensing arrangement for measuring the force applied by a user to rotate the pedal assembly in order to impart movement to the driven wheel; and
a pedal stroke analysis system carried by the bicycle that receives information from the sensing arrangement and that provides feedback to the user as to the application of force to the pedal assembly by the user while the bicycle is operated by the user.

2. The bicycle of claim 1, wherein the sensing arrangement is incorporated in a hub of the driven wheel of the bicycle.

3. The bicycle of claim 2, wherein the pedal stroke analysis system provides feedback to the user in the form of a graphic representation on a display mounted to the bicycle.

4. A system for providing information to a rider as to power applied by the rider during operation of a cycle having a frame and at least one wheel that is driven by operation of a rotatable pedal assembly, comprising a sensing arrangement for measuring the power applied by the rider to rotate the pedal assembly in order to impart movement to the driven wheel; and a pedal stroke analysis system that receives information from the sensing arrangement and that provides feedback to the user as to the application of power to the pedal assembly by the rider while the cycle is operated by the rider.

5. A method of providing information to a rider as to power applied by the rider during operation of a cycle having a frame and at least one wheel that is driven by operation of a rotatable pedal assembly, comprising the acts of rotating the pedal assembly; sensing the power applied by the rider to rotate the pedal assembly in order to impart movement to the driven wheel; and analyzing information from the sensing arrangement and providing feedback to the user as to the application of power to the pedal assembly by the rider while the cycle is operated by the rider.
